(19) United States
(12) Patent Application Publication
(10) Pub. No.: US 2024/0034628 A1
(43) Pub. Date: Feb. 1, 2024

(54) Graphitization Using Graphene Additives

(71) Applicant: ExxonMobil Technology and Engineering Company, Annandale, NJ (US)

(72) Inventor: Shiun Ling, Washington, NJ (US)

(73) Assignee: ExxonMobil Technology and Engineering Company, Annandale, NJ (US)

(21) Appl. No.: 18/214,346

(22) Filed: Jun. 26, 2023

Related U.S. Application Data
(60) Provisional application No. 63/369,442, filed on Jul. 26, 2022.

(51) Int. Cl. C01B 32/15

(52) U.S. Cl. CPC C01B 32/15

(57) ABSTRACT

Oxygen-containing graphenic nanomaterial (OGN)-doped novolac polymers suitable for producing graphitized carbon may be synthesized based on a correlation between (a) the amount of OGN and/or the oxygen content of the OGN and (b) at least one property of a resultant graphitized carbon. For example, a method may comprise: synthesizing an OGN-doped novolac polymer, wherein an amount of OGN and/or an oxygen content of the OGN used in the synthesizing is based on a correlation between (a) the amount of OGN and/or the oxygen content of the OGN and (b) at least one property of a resultant graphitized carbon; and carbonizing and graphitizing the OGN-doped novolac polymer to yield a graphitized carbon.

### FIELD OF INVENTION

The present application relates to oxygen-containing graphenic nanomaterials (OGN)-doped novolac polymers and graphitized carbon products produced therefrom and related methods.

### BACKGROUND

The nano- and micro-structures of carbon materials strongly affects their useful macro properties. For example, the non-graphitizing type or “hard” carbons have little porosity, high chemical resilience, and relatively low thermal conductivity, and are useful in applications such as refractories, linings, crucibles, and thermal barriers. The graphitic or “soft” carbons have high electrical conductivity, stable physicochemical property, long cycle life and are of low cost, and are useful in applications such as electrodes.

Graphitization is a heat-treatment process that converts the crystalline structure of carbon materials from non-graphitic carbon to graphitic carbon, and/or from graphitic carbon to one closer to graphite. The starting material and heat-treatment process contribute to the degree of graphitization in the resultant graphitized carbon. Because the nano- and micro-structures of resultant graphitized carbon strongly affects the macro properties, there has been strong interest in developing new methodologies to manipulate and control the nano- and micro-structure and properties of the graphitized carbon.

### SUMMARY OF INVENTION

The present application relates to OGN-doped novolac polymers and graphitized carbon products produced therefrom and related methods.

Methods of the present disclosure may comprise: synthesizing an OGN-doped novolac polymer, wherein an amount of OGN and/or an oxygen content of the OGN used in the synthesizing is based on a correlation between (a) the amount of OGN and/or the oxygen content of the OGN and (b) at least one property of a resultant graphitized carbon; and carbonizing and graphitizing the OGN-doped novolac polymer to yield a graphitized carbon.

Methods of the present disclosure may comprise: preparing a plurality of OGN-doped novolac polymers that vary in at least one of: an oxygen content of the OGN or an amount of the OGN; carbonizing and graphitizing the plurality of OGN-doped novolac polymers to yield a plurality of graphitized carbons; measuring at least one property of the graphitized carbons; and deriving a correlation between (a) the amount of OGN and/or the oxygen content of the OGN and (b) the at least one property of the graphitized carbons.

These and other features and attributes of the disclosed compositions and methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates an example method of the present disclosure for using correlation to produce graphitized carbon with desired properties from OGN-doped novolac polymers.

FIG. 2 illustrates an example method of the present disclosure for deriving correlations that may be useful in producing graphitized carbon from OGN-doped novolac polymers.

FIG. 3 shows an example of the graphitized novolac XRD spectrum, with insert showing its best-fit of (002) peak using two-component peaks.

FIG. 4 is an illustrative correlation between La and atomic percent oxygen including an example fit line (specifically polynomial in this figure).

### DETAILED DESCRIPTION

The present application relates to OGN-doped novolac polymers and graphitized carbon products produced therefrom and related methods. More specifically, the present disclosure uses OGN additives as internal templates during carbonization and graphitization to direct the nanostructure evolution of novolac polymers, which are themselves non-graphitizing carbon precursors, to produce graphitized carbons. That is, when neat novolac polymers are exposed to a heat-treatment process suitable for graphitizing materials (e.g., anthracene, an inherently graphitizing material), the resultant carbon product has very little to no graphitic structure. The OGN additives described herein may function as templates that cause the OGN-doped novolac polymers to yield highly graphitic products.

Further, the present application relates to correlations between properties of the OGN additives (e.g., oxygen content of the OGN), the concentration of the OGN additives in the OGN-doped novolac polymers, and the resultant characteristics (e.g., degree of graphitization, percent crystallization, and the like). Said correlation may allow for one to dial in nano- and micro-structures of resultant graphitized carbon product and, consequently, the desired properties (e.g., thermal conductivity, electrical conductivity, and the like) of the resultant graphitized carbon product. Said correlation may be updated as additional data is collected.

Examples of OGNs may include, but are not limited to, graphene oxide, reduced graphene oxide, graphene nanoplatelets, graphene nanopowder, the like, and any combination thereof.

The OGN may have an atomic percent of oxygen of about 0.5% to about 60% (or about 0.5% to about 5%, or about 1% to about 8%, or about 5% to about 25%, or about 10% to about 15%, or about 20% to about 40%, or about 25% to about 60%).

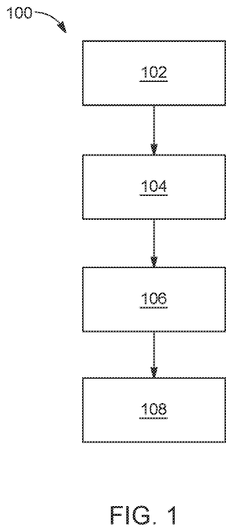

FIG. 1 illustrates an example method 100 of the present disclosure. A correlation 102 between (a) the amount of OGN and/or the oxygen content of the OGN and (b) at least one property of a resultant graphitized carbon may be used to ascertain a formulation 104 for an OGN-doped novolac polymer (e.g., the amount of OGN to include and/or an oxygen content (or a composition) of the OGN) to achieve desired properties in a graphitized carbon product.

Examples of properties of a graphitized carbon product may include, but are not limited to, a degree of graphitization, a percent crystallization, a crystalline domain size in the C-orientation, a crystalline domain size in the A-orientation, a graphitic interlayer spacing, the like, and any combination thereof.

A correlation 102 may be equations (e.g., linear equation, a polynomial equation, a logarithmic equation, and the like), graphs, tables, or other mathematical representations that correlate (a) an amount of OGN to at least one property of a resultant graphitized carbon (e.g., a 2-dimensional plot or a correlation function), (b) an oxygen content of the OGN to at least one property of a resultant graphitized carbon, (c) an amount of OGN and an oxygen content of the OGN to at least one property of a resultant graphitized carbon (e.g., a 3-dimensional graph or multivariable equation). For example, a formulation 104 may be ascertained based on a first correlation between an amount of OGN and a degree of graphitization of a resultant graphitized carbon and a second correlation between an amount of OGN, an oxygen content of the OGN, and a crystalline domain size in the C-orientation. In another example, a formulation 104 may be ascertained based on a first correlation between an amount of OGN, an oxygen content of the OGN, and a crystalline domain size in the A-orientation and a second correlation between an amount of OGN, an oxygen content of the OGN, and a crystalline domain size in the C-orientation. In yet another example, a formulation 104 may be ascertained based on a first correlation between an amount of OGN, an oxygen content of the OGN, and a percent crystallization; a second correlation between an oxygen content of the OGN and a crystalline domain size in the C-orientation and/or in the A-orientation; and a third correlation between an amount of OGN and a degree of graphitization. One skilled in the art will recognize that the foregoing are only a few of many ways to ascertain a formulation based on one or more correlations.

The formulation 104 may then be the basis for synthesizing an OGN-doped novolac polymer 106. For example, the specific oxygen content OGN of the formulation 104 may not be available and may be substituted in the synthesis for the closest available oxygen content OGN.

Synthesis of the OGN-doped novolac polymer 106 may by any suitable method. For example, polymer precursors (e.g., cresylic acids and a formaldehyde source) may be mixed with an OGN (e.g., dry OGN or OGN dispersed in a suitable solvent like ethanol). Then, an initiator (e.g., hydrochloric acid) may be added to the mixture to cause the condensation reaction to start. Alternatively, the OGN may be added after the condensation reaction is initiated. Preferably, the OGN is well dispersed during the condensation reaction where incorporation of the OGN may preferably be via OGN dispersed in a suitable solvent like ethanol that evaporates readily.

The OGN may be present in the OGN-doped novolac polymer at about 0.1 wt % to about 40 wt % (or about 0.1 wt % to about 5 wt %, or about 1 wt % to about 10 wt %, or about 5 wt % to about 20 wt %, or about 10 wt % to about 30 wt %, or about 25 wt % to about 40 wt %) of the OGN-doped novolac polymer.

The synthesized OGN-doped novolac polymer 106 may then be heat treated to effect carbonization and graphitization and to produce a graphitized carbon 108. Before carbonization and graphitization, the OGN-doped novolac polymer 106 may be placed into a mold or otherwise molded into a desired shape (e.g., a block, a cylinder, a plate, and the like).

Carbonizing generally occurs at a lower temperature than graphitization and causes the OGN-doped novolac polymer to be converted to essentially all carbon (e.g., remove the oxygen and impurity components of the novolac polymer and the OGN) and other volatile compounds to be removed from the sample. Carbonizing may occur at about 400° C. to about 1000° C. (or about 400° C. to about 600° C., or about 500° C. to about 700° C., or about 600° C. to about 800° C., or about 700° C. to about 1000° C.) in an inert atmosphere (e.g., N₂, Ar, and the like) for about 5 minutes to about 24 hours or more (or about 5 minutes to about 3 hours, or about 1 hour to about 6 hours, or about 3 hours to about 12 hours, or about 12 hours to about 24 hours).

Graphitizing may occur at about 1000° C. to about 3000° C. (or about 1000° C. to about 1750° C., or about 1500° C. to about 2250° C., or about 2000° C. to about 3000° C., or about 2000° C. to about 2500° C., or about 2200° C. to about 2700° C., or about 2500° C. to about 3000° C.) in an inert atmosphere (e.g., Ar, and the like) for about 5 minutes to about 24 hours or more (or about 5 minutes to about 3 hours, or about 1 hour to about 6 hours, or about 3 hours to about 12 hours, or about 12 hours to about 24 hours).

The resultant graphitized carbon 108 may be characterized by one or more properties (e.g., a degree of graphitization, a percent crystallization, a crystalline domain size in the C-orientation, a crystalline domain size in the A-orientation, a graphitic interlayer spacing, the like, and any combination thereof).

For example, the graphitized carbon may have a degree of graphitization (g) from about 0.25 to about 0.65 (or about 0.25 to about 0.45, or about 0.30 to about 0.55, or about 0.40 to about 0.60, or about 0.50 to about 0.65). The graphitized carbon may have a percent crystallization from about 50% to about 100% (or about 50% to about 75%, or about 55% to about 80%, or about 65% to about 90%, or about 75% to about 100%). The graphitized carbon may have a crystalline domain size in the C-orientation for a crystalline fraction of about 5 nm to about 50 nm and for an amorphous fraction of less than 1 nm to about 25 nm. The graphitized carbon may have a crystalline domain size in the A-orientation for a crystalline fraction of about 5 nm to about 250 nm (or about 5 nm to about 50 nm, or about 25 nm to about 100 nm, or about 60 nm to about 150 nm, or about 75 nm to about 250 nm). The graphitized carbon may have a graphitic interlayer spacing of about 0.3335 nm to 0.35 nm.

Therefore, FIG. 1 illustrates a method where a correlation may be used inform the production of a graphitized carbon with desired properties (or near to the desired properties).

The produced graphitized product and measured properties may be used to update the correlations for future use.

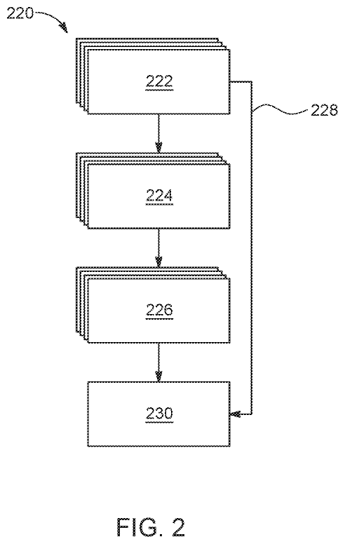

FIG. 2 illustrates an example method 220 of the present disclosure for deriving correlations that may be useful in producing graphitized carbon from OGN-doped novolac polymers. Here, a plurality of OGN-doped novolac polymers 222 are prepared (e.g., using the methods and conditions describe in FIG. 1) that vary in at least one of: an oxygen content of the OGN or an amount of the OGN. The plurality of OGN-doped novolac polymers 222 may then be carbonized and graphitized (e.g., using the methods and conditions describe in FIG. 1) to produce a plurality of graphitized carbons 224.

At least one property 226 (e.g., a degree of graphitization, a percent crystallization, a crystalline domain size in the C-orientation, a crystalline domain size in the A-orientation, a graphitic interlayer spacing, the like, and any combination thereof) of the plurality of graphitized carbons 224 may then be measured.

A correlation 228 between the at least one property 226 of the plurality of graphitized carbons 224 and the oxygen content of the OGN and/or the amount of the OGN 228 of the OGN-doped novolac polymers 222 may be derived. Again, the correlation 228 may be an equation, a graph, a table, or other mathematical representation.

### Test Methods

X-ray diffraction (XRD) may be used to ascertain a degree of graphitization (g), a percent crystallization, a crystalline domain size in the C-orientation (L_{c}), a crystalline domain size in the A-orientation (L_{A}), and a graphitic interlayer spacing (d₀₀₂).

The graphitic interlayer spacing d₀₀₂ may be determined using the (002) peak location with Bragg's equation (EQ. 1).

nλ=2d sin θ EQ. 1

where n=1, λ=0.15406 nm is the Cu K_{α}x-ray wavelength, d=d₀₀₂ is the graphitic interlayer spacing, and 2θ is the (002) peak location where θ is known as the Bragg angle of the peak.

The crystalline domain sizes in the C- and A-orientations, L_{c} and Lₐ, may be determined with the (002) and (110) peak widths, respectively, using the Scherrer equation (EQ. 2).

$$L = \frac{K λ}{βcosθ} \qquad EQ . 2$$

where L=L_{c} or Lₐ, is the crystalline graphitic domain size, K is a dimensionless shape factor taken to be 0.9 herein, β is the XRD peak width FWHM (full-width at half-maximum intensity) of (002) peak for L_{c} and (110) peak for Lₐ, and θ is the Bragg angle of the peak.

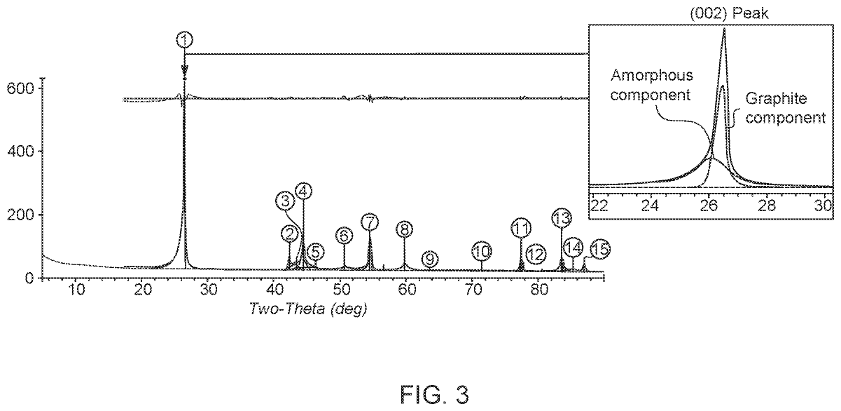

The (002) and (110) peaks may be further analyzed and deconvoluted to have best fit with two component peaks. The peak at lower-θ has broader peak width, and thus is believed to be due to the amorphous (or turbostratic) carbon. The other peak is at higher-θ with narrower peak width, and thus was believed to be due to the crystalline carbon. FIG. 3 shows an example of the graphitized novolac XRD spectrum, with insert showing its best-fit of (002) peak using two-component peaks. The numbered vertical lines provide references for graphite peak locations. Using the de-convoluted two component peaks, the %-crystallinity is calculated from the integrated intensities of these two component peaks using EQ. 3.

$$\% crystallinity = \frac{{I}_{c}}{{I}_{c} + {I}_{a}} \qquad EQ . 3$$

where I_{c} and Iₐ are the integrated peak area of the crystalline and amorphous component peaks, respectively.

The degree of graphitization (g) may be calculated from the interlayer spacing d₀₀₂ using EQ. 4.

$$g = \frac{3.44 - {d}_{002}}{3.44 - 3.354} \qquad EQ . 4$$

where d₀₀₂ is the measured interlayer spacing in Å, 3.354 is the interlayer spacing of graphite in Å, and 3.440 is the interlayer spacing for turbostratic carbon.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### Additional Embodiments

Embodiment 1. A method comprising: synthesizing an oxygen-containing graphenic nanomaterial (OGN)-doped novolac polymer, wherein an amount of OGN and/or an oxygen content of the OGN used in the synthesizing is based on a correlation between (a) the amount of OGN and/or the oxygen content of the OGN and (b) at least one property of a resultant graphitized carbon; and carbonizing and graphitizing the OGN-doped novolac polymer to yield a graphitized carbon.

Embodiment 2. The method of Embodiment 1, wherein the at least one property of the resultant graphitized carbon comprises one or more of: a degree of graphitization, a percent crystallization, a crystalline domain size in the C-orientation, a crystalline domain size in the A-orientation, or a graphitic interlayer spacing.

Embodiment 3. The method of any preceding Embodiment, wherein the OGN is present in the OGN-doped novolac polymer at about 0.1 wt % to about 40 wt %.

Embodiment 4. The method of any preceding Embodiment, wherein the OGN is present in the OGN-doped novolac polymer at about 10 wt % to about 15 wt %.

Embodiment 5. The method of any preceding Embodiment, wherein the OGN comprises one or more of: graphene oxide, reduced graphene oxide, graphene nanoplatelets, or graphene nanopowder.

Embodiment 6. The method of any preceding Embodiment, wherein the OGN has an atomic percent of oxygen of about 0.5% to about 60%.

Embodiment 7. The method of any preceding Embodiment, wherein the graphitized carbon has a degree of graphitization (g) from about 0.25 to about 0.65.

Embodiment 8. The method of any preceding Embodiment, wherein the graphitized carbon has a percent crystallization from about 50% to about 100%.

Embodiment 9. The method of any preceding Embodiment, wherein the graphitized carbon has a crystalline domain size in the C-orientation for a crystalline fraction of about 5 nm to about 50 nm and for an amorphous fraction of less than 1 nm to about 25 nm.

Embodiment 10. The method of any preceding Embodiment, wherein the graphitized carbon has a crystalline domain size in the A-orientation for a crystalline fraction of about 5 nm to about 250 nm.

Embodiment 11. A method comprising: preparing a plurality of oxygen-containing graphenic nanomaterial (OGN)-doped novolac polymers that vary in at least one of: an oxygen content of the OGN or an amount of the OGN; carbonizing and graphitizing the plurality of OGN-doped novolac polymers to yield a plurality of graphitized carbons; measuring at least one property of the graphitized carbons; and deriving a correlation between (a) the amount of OGN and/or the oxygen content of the OGN and (b) the at least one property of the graphitized carbons.

Embodiment 12. The method of Embodiment 11, wherein the at least one property of the graphitized carbons comprises one or more of: a degree of graphitization, a percent crystallization, a crystalline domain size in the C-orientation, a crystalline domain size in the A-orientation, or a graphitic interlayer spacing.

Embodiment 13. The method of any of Embodiments 11-12, wherein the OGN comprises one or more of: graphene oxide, reduced graphene oxide, graphene nanoplatelets, or graphene nanopowder.

Embodiment 14. The method of any of Embodiments 11-13, wherein the correlation is an equation, a graph, a table, and/or other mathematical representations.

Embodiment 15. The method of any of Embodiments 11-14, wherein the amount of the OGN is varied between about 0.1 wt % and about 40 wt %.

Embodiment 16. The method of any of Embodiments 11-15, wherein the oxygen content of the OGN is varied between about 0.5 at % to about 60 at %.

To facilitate a better understanding of the embodiments of the present invention, the following examples of preferred or representative embodiments are given. In no way should the following examples be read to limit, or to define, the scope of the invention.

### EXAMPLES

The oxygen content of OGN additives used in the production of OGN-doped novolac polymers was characterized with x-ray photoelectron spectroscopy (XPS) and provided in Table 1. The size of the OGN additives were based on the manufacturer's specifications.

TABLE 1

| | | Oxygen Content |
|---|---|---|
| OGN Additive | Size | (at %) |
| Reduced graphene oxide (rGO) | 300 nm-800 nm | 14.40% |
| Graphene nanoplatelets (GPL) | 1 μm-2 μm | 5.30% |
| Graphene nanopowder (GNP) | 10 μm | 1.20% |
| Graphene oxide (GO1) | 1 μm | 35.3% |
| Graphene oxide (GO2) | 300 nm-800 nm | 30.8% |

Six samples were prepared: one control novolac polymer without OGN additive and five OGN-doped novolac polymers with 2.5 wt % OGN additive (one sample for each of the GN additive in Table 1). The sample preparation was conducted at about 70° C., and included mixing phenol and formaldehyde in a molar ratio of about 1. Then, concentrated hydrochloric acid was added as the initiator until a uniform slurry was obtained. Shortly after initiation of the condensation reaction, the OGN additive dispersed in ethanol was added (except for in the control sample where no OGN additive was added).

The samples were then carbonized and graphitized in a tube furnace. Specifically, the control novolac polymer sample, the rGO-doped novolac polymer sample, the GPL-doped novolac polymer sample, and the GNL-doped novolac polymer sample were carbonized at about 500° C. for about 5 hours in a nitrogen atmosphere and graphitized at about 2200° C. for about 2 hours in an argon atmosphere. The GO1-doped novolac polymer sample and the G02-doped novolac polymer sample were carbonized at about 600° C. for about 3 hours in a nitrogen atmosphere and graphitized at about 2500° C. for about 1 hour in an argon atmosphere. It should be noted that, under these conditions, the differences in temperature and duration are not expected to have a significant impact on the final product composition.

TABLE 2

| | | GNP- | GPL- | rGO- | GO2- | GO1- |
|---|---|---|---|---|---|---|
| | control | doped | doped | doped | doped | doped |
| | novolac | novolac | novolac | novolac | novolac | novolac |
| Property | polymer | polymer | polymer | polymer | polymer | polymer |
| d₀₀₂ crystal. | 3.356 | 3.338 | 3.354 | 3.337 | 3.362 | 3.372 |
| (Å) | | | | | | |
| d₀₀₂ amorph. | 3.420 | 3.404 | 3.399 | Not | 3.485 | 3.546 |
| (Å) | | | | measured | | |
| L_{c} crystal. | 30 | 35 | 35 | 39 | 24 | 9 |
| (nm) | | | | | | |
| L_{c} amorph. | 7 | 14 | 9 | Not | 3 | 4 |
| (nm) | | | | measured | | |
| Lₐ crystal. | 53 | 62 | 126 | 135 | 70 | 12 |
| (nm) | | | | | | |
| I_{c} | 72 | 80 | 74 | 100 | 76 | 49 |
| Iₐ | 28 | 20 | 26 | Not | 24 | 51 |
| | | | | measured | | |
| % | 72 | 80 | 74 | 100 | 76 | 49 |
| crystallinity | | | | | | |
| g (degree of | 0.428 | 0.520 | 0.439 | 0.525 | 0.392 | 0.345 |
| crystallinity) | | | | | | |

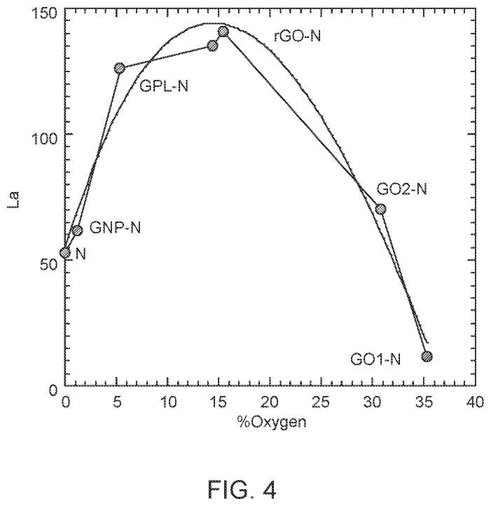

The values in Tables 1 and 2 were used to derive correlations between oxygen content of the OGN additive and each of the properties of the graphitized carbon. FIG. 4 is an illustrative correlation between La and atomic percent oxygen. FIG. 4 also includes a best fit line, which in this instance is polynomial, however other curve fitting equation types may be used. The graph and/or the best fit line may be used as a correlation in the methods described herein. Further, samples prepared with varying weight percent of the OGN additives may be carbonized, graphitized, and characterized to provide data points to produce a 3-dimensional graph or fit that correlates Lₐ with atomic percent oxygen and weight percent OGN additive.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
synthesizing an oxygen-containing graphenic nanomaterial (OGN) -doped novolac polymer, wherein an amount of OGN and/or an oxygen content of the OGN used in the synthesizing is based on a correlation between (a) the amount of OGN and/or the oxygen content of the OGN and (b) at least one property of a resultant graphitized carbon; and
carbonizing and graphitizing the OGN-doped novolac polymer to yield a graphitized carbon.

2. The method of claim 1, wherein the at least one property of the resultant graphitized carbon comprises one or more of: a degree of graphitization, a percent crystallization, a crystalline domain size in the C-orientation, a crystalline domain size in the A-orientation, or a graphitic interlayer spacing.

3. The method of claim 1, wherein the OGN is present in the OGN-doped novolac polymer at about 0.1 wt % to about 40 wt %.

4. The method of claim 1, wherein the OGN is present in the OGN-doped novolac polymer at about 10 wt % to about 15 wt %.

5. The method of claim 1, wherein the OGN comprises one or more of: graphene oxide, reduced graphene oxide, graphene nanoplatelets, or graphene nanopowder.

6. The method of claim 1, wherein the OGN has an atomic percent of oxygen of about 0.5% to about 60%.

7. The method of claim 1, wherein the graphitized carbon has a degree of graphitization (g) from about 0.25 to about 0.65.

8. The method of claim 1, wherein the graphitized carbon has a percent crystallization from about 50% to about 100%.

9. The method of claim 1, wherein the graphitized carbon has a crystalline domain size in the C-orientation for a crystalline fraction of about 5 nm to about 50 nm and for an amorphous fraction of less than 1 nm to about 25 nm.

10. The method of claim 1, wherein the graphitized carbon has a crystalline domain size in the A-orientation for a crystalline fraction of about 5 nm to about 250 nm.

11. A method comprising:
preparing a plurality of oxygen-containing graphenic nanomaterial (OGN) -doped novolac polymers that vary in at least one of: an oxygen content of the OGN or an amount of the OGN;
carbonizing and graphitizing the plurality of OGN-doped novolac polymers to yield a plurality of graphitized carbons;
measuring at least one property of the graphitized carbons; and
deriving a correlation between (a) the amount of OGN and/or the oxygen content of the OGN and (b) the at least one property of the graphitized carbons.

12. The method of claim 11, wherein the at least one property of the graphitized carbons comprises one or more of: a degree of graphitization, a percent crystallization, a crystalline domain size in the C-orientation, a crystalline domain size in the A-orientation, or a graphitic interlayer spacing.

13. The method of claim 11, wherein the OGN comprises one or more of: graphene oxide, reduced graphene oxide, graphene nanoplatelets, or graphene nanopowder.

14. The method of claim 11, wherein the correlation is an equation, a graph, a table, and/or other mathematical representations.

15. The method of claim 11, wherein the amount of the OGN is varied between about 0.1 wt % and about 40 wt %.

16. The method of claim 11, wherein the oxygen content of the OGN is varied between about 0.5 at % to about 60 at %.
